(19) United States
(12) Patent Application Publication
(10) Pub. No.: US 2005/0042989 A1
(43) Pub. Date: Feb. 24, 2005

(54) Device and method for antenna matching

(75) Inventor: Chia-Cheng Ho, Taipei (TW)

Correspondence Address: BIRCH STEWART KOLASCH & BIRCH, PO BOX 747, FALLS CHURCH, VA, 22040-0747, US

(73) Assignee: BENQ CORPORATION, Tao Yuan (TW)

(21) Appl. No.: 10/925,000

(22) Filed: Aug. 25, 2004

(30) Foreign Application Priority Data
Aug. 22, 2003 (TW) 92123089

(51) Int. Cl. H04B 1/44

(52) U.S. Cl. 455/78; 455/82

(57) ABSTRACT

The present invention provides a device and method for antenna matching applied in a transceiver. Wherein, the transceiver has a transmission module and a receiving module. The antenna matching device includes a matching circuit, a duplexer, a circulator, a control unit, and a coupler. Wherein, the matching circuit adjusts the matching impedance according to an adjusting signal and generates a reflection signal. The duplexer receives the reflection signal and a receiving signal and respectively sent the received two signals to the control unit and the receiving module according to their frequencies. The control unit, according to the reflection signal, estimates the adjusting signal for adjusting the matching circuit to an optimal state of the load impedance of the matching antenna, such that the antenna gain may is maximized, and a best efficiency is obtained no matter during receiving or transmission.

### FIELD OF THE INVENTION

The present invention relates to a device and method for antenna matching, more particularly, to an antenna matching device and method for antenna matching capable of reaching a matching optimization by means of a circulator and a duplexer.

### BACKGROUND OF THE INVENTION

In a traditional transmission system, such as the modulation system of CDMA (Code Division Multiple Access) or the modulation system of FDMA (Frequency Division Multiple Access) with reference to FIG. 1, a transceiver 10 includes: an antenna 11, a matching circuit 12, a duplexer 13, an insulator 14, a receiving module 16, and a transmission module 15. Wherein, the duplexer 13 has function of frequency division transmitting and signal receiving, and the insulator 14 is unidirectional. Thus, while the power transmitted by the transmission module 15 is being transmitted to the antenna 11 through the insulator 14, the duplexer 13, and the matching circuit 12, since the insulator 14 is unidirectional, the components in the transmission module 15 can avoid the damages caused by the reflecting power reflected by the antenna 11, furthermore, the matching circuit 12 is being matched with the load impedance of the antenna so that the reflecting power is minimized.

The aforesaid transceiver 10 usually sets up the load impedance of the antenna 11 and determines the impedance of the matching circuit 12 by field test or by assuming it is under an ideal condition. However, following the change of weather conditions, the actual load of the antenna 11 will change as well. When the load of the antenna 11 changes, the reflecting power will change accordingly, thus, the previously matched matching circuit 12 is no longer an optimal match, and the antenna gain of the transceiver 10 will be also reduced. Under the circumstance, the output power of the power amplifier in the transceiver 10 will be damaged, and the intensity of the signal received at the receiving end will be influenced. Hence, the output power of the amplifier should be adjusted such that the stability of the transmitting power can be maintained. Nevertheless, by doing so, the current consumption will increase, and the working efficiency of the transceiver will decrease.

### SUMMARY OF THE INVENTION

The primary objective of the present invention is to provide an antenna matching device adapted for a transceiver for optimizing the matching load impedance of the antenna of the transceiver, the antenna matching device comprising: a matching circuit, a frequency division unit, a circulator, and a control unit, and the transceiver having: a transmission module, for sending a transmission signal to the antenna matching device; and a receiving module.

Wherein, the matching circuit adjusts the load impedance of the antenna according to an adjusting signal and has a first end and a second end, that the second end is adapted for receiving a receiving signal; the circulator is coupled to the first end of the matching circuit for enabling a transmission signal to be received and fed into the matching circuit; the matching circuit generates a reflection signal corresponding to the transmission signal that is transmitted and the receiving signal to the circulator through the first end of the matching circuit; the frequency division unit, which can be a duplexer, receives the reflection signal and the receiving signal from the circulator, and outputs signal intended to the control unit and the receiving module according to the frequencies of the reflection signal and the receiving signal; and the control unit is coupled to the matching circuit that is capable of generating the adjusting signal according to the reflection signal.

Another objective of the present invention is to provide a transceiver, which including a receiving module, a transmission module, a matching circuit, a control unit, a circulator and a frequency division unit, wherein the transmission module is used for sending a transmission signal; the matching circuit is used for adjusting a matching impedance according to an adjusting signal, the matching circuit having a first end and a second end, the second end for receiving a receiving signal; the control unit coupled to the matching circuit, is used for generating the adjusting signal according to a reflection signal; a circulator coupled to the first end of the matching circuit, is used for guiding the transmission signal to the matching circuit, the matching circuit is capable of generating the reflection signal corresponding to the transmission signal and thereafter transmitting the reflection signal and the receiving signal to the circulator through the first end; and the frequency division unit coupled to the circulator, is used for receiving the reflection signal and the receiving signal from the circulator and outputting the reflection signal and the receiving signal to the control unit and the receiving module according to frequency of the reflection signal and the receiving signal.

Another objective of the present invention is to provide an antenna matching method, which is executed by means of the aforesaid antenna matching device. The method comprises the following steps:
a. utilizing a circulator to obtain a reflection value generating by the matching circuit according to a transmitting power of the transceiver by the circulator;
b. providing an adjusting signal by a control circuit to the matching circuit and defining a reference value and a critical value using the control unit; and
c. adjusting the adjusting voltage according to the difference between the reference value and the reflection value until the difference substantially equal to the critical value.

Applying the aforementioned antenna matching device and method of the same will enable the transceiver to have an optimal matching state at the antenna side, such that the intensity of both the transmission signal and the receiving signal is maximized.

Following drawings are cooperated to describe the detailed structure and its connective relationship according to the invention for facilitating your esteemed members of reviewing committee in understanding the characteristics and the objectives of the invention.

### BRIEF DESCRIPTION OF THE DRAWINGS

FIG. 1 is a block diagram depicting a transceiver of the prior arts.

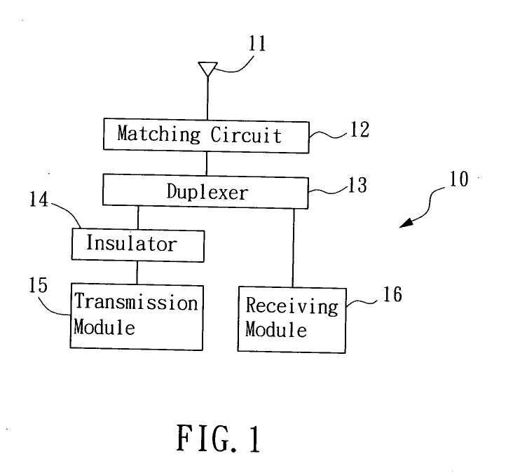

FIG. 2A is a first preferred embodiment of the antenna matching device adapted for a transceiver according to the present invention.

FIG. 2B is a second preferred embodiment of the antenna matching device adapted for a transceiver according to the present invention.

FIG. 3 is a third preferred embodiment of the antenna matching device adapted for a transceiver according to the present invention.

FIG. 4 is a flowchart of the method for antenna matching according to the present invention.

FIG. 5 is a flowchart for defining a matching critical value Opt by the antenna matching method of the present invention.

FIG. 6 is a flowchart of another preferred embodiment of the present invention depicting an antenna matching method.

### DETAILED DESCRIPTION OF THE INVENTION

For your esteemed members of reviewing committee to further understand and recognize the fulfilled functions and structural characteristics of the invention, several preferable embodiments cooperating with detailed description are presented as the follows.

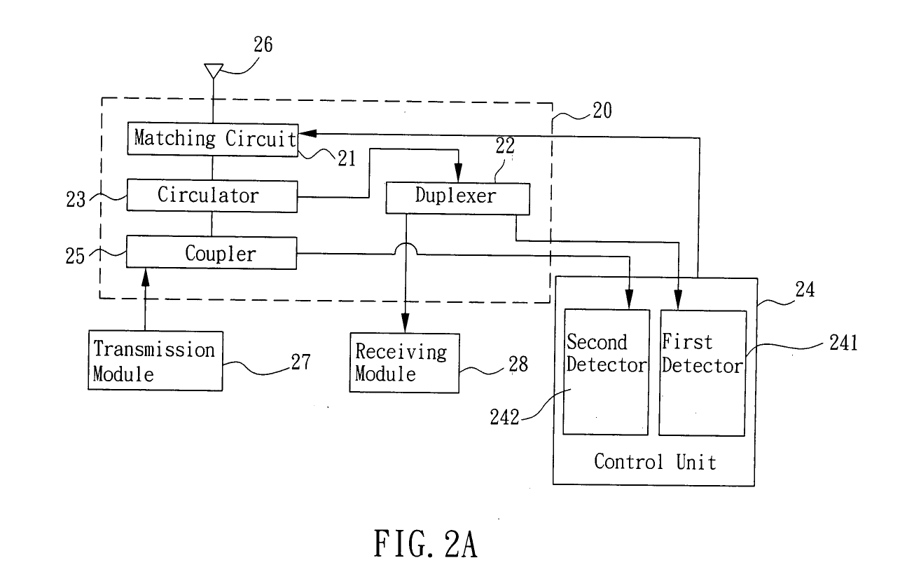

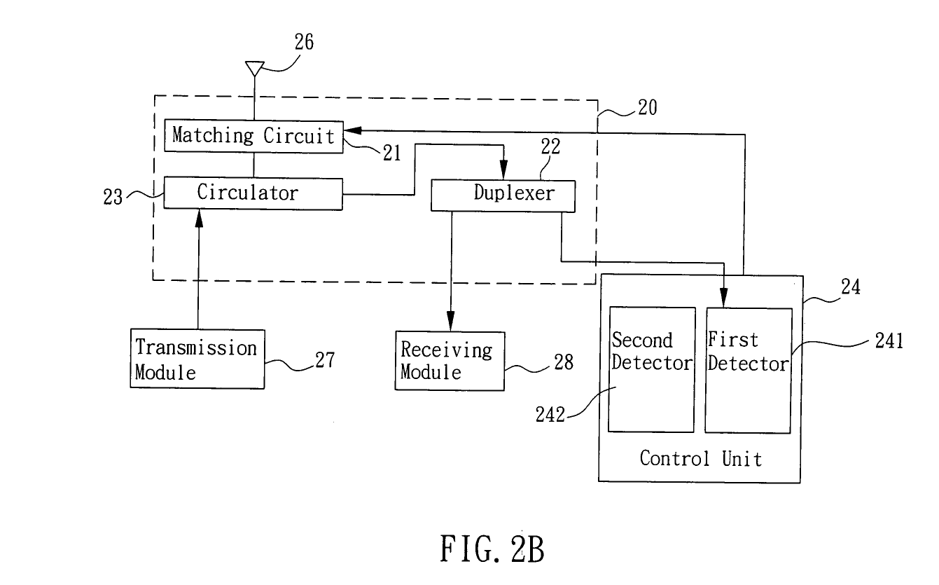

Please refer to FIG. 2A, which is a first preferred embodiment of the antenna matching device adapted for a transceiver according to the present invention. The transceiver has a transmission module 27 and a receiving module 28. The antenna-matching device 20 includes: a matching circuit 21, a duplexer 22, a circulator 23, a control unit 24, and a coupler 25.

The matching circuit 21 having a first end and a second end, the second end is coupled to an antenna 26, is capable of adjusting the matching impedance of the antenna 26 according to an adjusting signal such that a reflection signal of the antenna 26 is minimized to reach the optimization of matching, and the matching circuit 21 will also generate a reflection signal in response to a transmission signal of the transmission module 27. In the preferred embodiment as seen in FIG. 2, the adjusting signal is a voltage ranged between a maximal voltage Vmax and a minimal voltage Vmin.

The circulator 23 is a 3-port circulator that the first port of the circulator 23 is coupled to the coupler 25 for receiving the transmission signal, the second port is coupled to the second end of the matching circuit 21 for guiding the transmission signal into the matching circuit 21, the third port is coupled to the duplexer 22 for guiding the reflection signal and a receiving signal into the duplexer 22. However, the circulator is unidirectional, such that the signal received at the first port is outputted from the second port, and the signal received at the second port is outputted from the third port, and the signal received at the third port is outputted from the first port. The signal transmission of the circulator 23 is irreversible to thereby prevent the reflection signal from being transmitted into the transmission module 27 so as to cause any damage.

The duplexer 22 receives the reflection signal and the receiving signal and outputs both signals respectively to the control unit 24 and the receiving module 28 according to their frequencies.

The control unit 24 has a first detector 241 coupled to the duplexer 22 and a second detector 242 coupled to the matching circuit 21. The control unit 24 estimates the adjusting signal according to the reflection signal to thereby control the matching circuit 21.

When the transmission module 27 emits the transmission signal (the transmission signal has a first power), the coupler 25 will sample a second power therein and send the second power to the second detector 242 in the control unit 24. The circulator 23 will transmit the first power to the matching circuit 21 to be launched through the antenna 26 and to generate the aforesaid reflection signal having a reflection power. The reflection power then will be fed into the second port of the circulator 23 and transmitted to the duplexer 22 coupled to the third port of the circulator 23. By the frequency division characteristic of the duplexer 22, the reflection power is transmitted to the first detector 241 in the control unit 24. Wherein, the second power is a designated proportion of the first power, thus, the difference between the reflection power and the transmission power is defined by the measures of the second power and the first power, and the second power is taken as a first reference value to be compared with the reflection power detected by the first detector 241 repetitiously so as to obtain an adjusting signal for adjusting the matching circuit 21, such that the reflection power of the antenna is minimized and the optimization of matching is achieved.

When the matching network is optimized using the mechanism for detecting reflection power, the antenna gain is at its maximum and the receiving quality of the wireless transmission is also optimized. For the receiving module 28 to receive a signal, the signal will first be received by the antenna, and then is transmitted to the second port of the circulator 23 so as to be outputted from the third port of the circulator 23 to the duplexer 22 for filtering noises and thereafter sending the signal to the receiving module 28.

Please refer to FIG. 2B, which is a second preferred embodiment of the antenna matching device adapted for a transceiver according to the present invention. The difference between the first preferred embodiment and the second preferred embodiment is that the coupler 25 is eliminated in the second preferred embodiment. As seen in FIG. 2, the first power emitted from the transmission module 27 is transmitted directly to the matching circuit 21 through the circulator 23, thus, the transmitted first power will be launched by the antenna 26 and a reflection power is generated in the matching circuit 21, further, the circulator 23 will transmit the reflection power to the first detector 241 of the control unit 24 such that an adjusting signal is obtained using the reflection power cooperating with a second reference value predefined in the second detector 242 for adjusting the matching circuit 21so as to minimize the reflection power and therefore reach an optimization of matching.

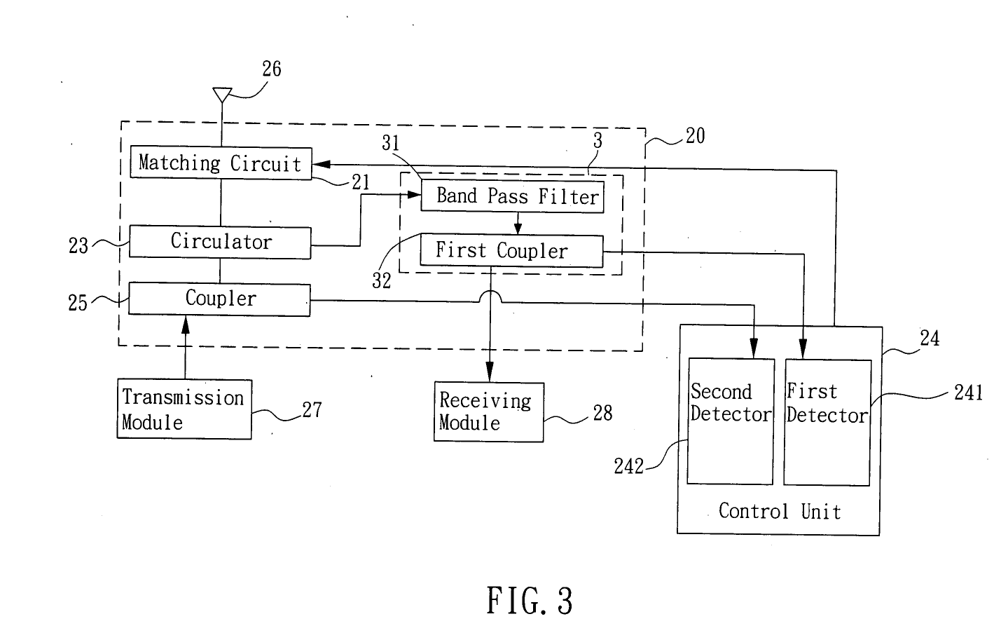

Please refer to FIG. 3, which is a third preferred embodiment of the antenna matching device adapted for a transceiver according to the present invention. As seen in FIG. 3, the transceiver has a transmission module 27 and a receiving module 28, and the antenna matching device 30 includes: a matching circuit 21, a frequency division unit 3, a circulator 23, a coupler 25, and a control unit 24. The actuation principle of the second preferred embodiment is the same as that of the first preferred embodiment, so a repetitious description is not presented herein. The difference between the two embodiments is that the frequency division unit 3 of the second embodiment is composed of a band pass Filter 31 and a first coupler 32. The frequency division unit 3 is capable of removing noises and distinguishing a reflection signal and a receiving signal, and the frequency division unit 3 also can send the receiving signal into the receiving module 28 and sends the reflection signal into the first detector 241 using the first coupler 32.

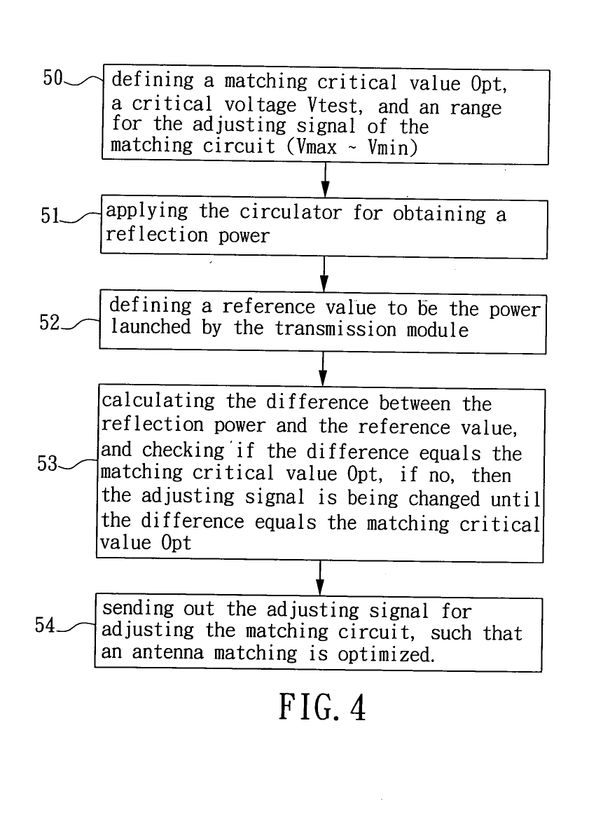

Please refer to FIG. 4, which is a flowchart of the method for antenna matching according to the present invention. As seen, the method for matching optimization is exercised using the device of FIG. 2A and comprises the following steps:
Step 50: defining a matching critical value Opt, a critical voltage Vtest, and an range for the adjusting signal of the matching circuit, i.e. (Vmax˜Vmin), such that the matching critical value Opt and the critical voltage value Vtest can paired up as the optimal match of the matching circuit;
Step 51: applying the circulator 23 for obtaining a reflection power;
Step 52: defining a reference value as the power launched by the transmission module 27;
Step 53: calculating the difference between the reflection power and the reference value, and checking if the difference equals the matching critical value Opt, if no, then the adjusting signal is being changed until the difference equals the matching critical value Opt;
Step 54: sending out the adjusting signal for adjusting the matching circuit 21, such that an antenna matching is optimized.

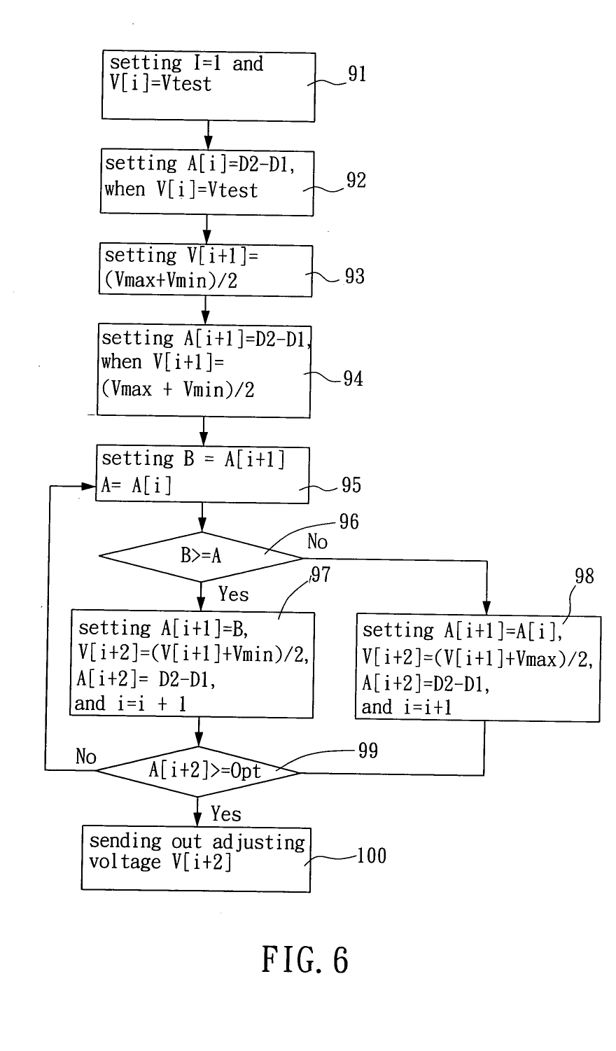

Please refer to FIG. 6, which is a flowchart of another preferred embodiment of the present invention depicting an antenna matching method. The method for matching optimization is exercised using the device of FIG. 2A. The Step 91 to Step 100 described thereinafter is the algorithm for finding the optimal match for the antenna matching device, wherein, first, utilizing an index and a register for adjusting the adjusting voltage of the matching circuit 21; secondly, fetching the difference between the first detector and the second detector to check if the foregoing difference equals a critical matching value Opt; finally, an adjusting voltage of the matching circuit 21 enabling the difference to equal the critical matching value Opt is obtained and used for adjusting the matching circuit 21, such that the optimization of the matching circuit is accomplished.
Step 91: defining a matching critical value Opt, a critical voltage Vtest, an range for the adjusting signal of the matching circuit (Vmax˜Vmin), an index i=1, and an adjusting voltage (V[i]=Vtest) of the matching network;
Step 92: setting A[i]=D2−D1, when V[i]=Vtest, wherein D1 is the power value of the first detector, and D2 is the power value of the second detector;
Step 93: setting V[i+1]=(Vmax+Vmin)/2, wherein Vmax is the maximal voltage of the adjusting voltage of the matching network, and Vmin is the minimal voltage of the adjusting voltage of the matching network;
Step 94: setting A[i+1]=D2−D1, when V[i+1]=(Vmax +Vmin)/2;
Step 95: setting the second register B=A[i+1] and the first register A=A[i];
Step 96: checking if the second register B is larger than the first register A; if so, executing Step 97; otherwise, executing Step 98;
Step 97: setting A[i+1]=B, V[i+2]=(V[i+1]+Vmin)/2, A[i+2]=D2−D1, and i=i+1;
Step 98: setting A[i+1]=A[i], V[i+2]=(V[i+1]+Vmax)/2, A[i+2]=D2−D1, and i=i+1;
Step 99: checking if A[i+2] is larger than the matching critical value Opt; if so, executing Step 100; otherwise, executing Step 95 to Step 99; and
Step 100: sending out adjusting voltage V[i+2] for matching optimization.

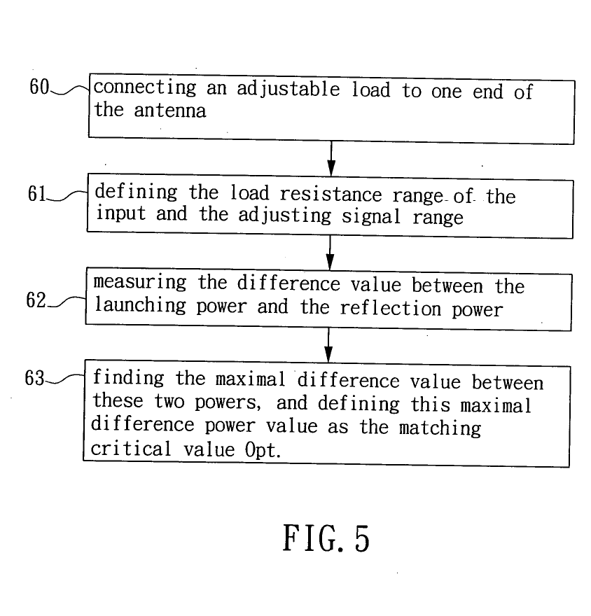

Please refer to FIG. 5, which is a flowchart for defining a matching critical value Opt by the antenna matching method of the present invention. As shown, the method uses an adjustable load to restrict the range of load impedance and a voltage range of the adjusting signal (the maximal voltage is Vmax and the minimal voltage is Vmin), such that a matching critical value Opt and a critical voltage value Vtest are defined. The foregoing method includes following steps:
Step 60: connecting an adjustable load to an end of the antenna;
Step 61: restricting the range of inputted load impedance and the adjusting signal range;
Step 62: calculating the difference between the transmission power and the reflection power; and
Step 63: finding the maximum difference between the transmission power and the reflection power, and defining the value of the maximum difference as the matching critical value Opt, and adjusting signal of the matching circuit 21 is the critical voltage value Vtest while the foregoing power difference is at its maximum.

According to aforementioned description, the antenna matching device according to the present invention combines the unidirectional circulator 23 and the duplexer 22 having the frequency division characteristic to send out the transmission power from the antenna 26 through the circulator 23 and measure the reflection power caused by defective match, such that the matching circuit 21 is adjusted using the adjusting signal to reach an optimal load impedance of antenna matching. Under this optimal state, the antenna gain is maximized so that an optimal effect will be obtained no matter during transmission or receiving.

However, the aforementioned description is only the preferred embodiments according to the invention and, of course, can not be applied as a limitation to the field of the invention, and any equivalent variation and modification made according to the claims claimed thereinafter still possess the merits of the invention and are still within the spirits and the ranges of the invention, so they should be deemed as a further executing situation of the invention.

1. An antenna matching device adapted for a transceiver, the transceiver having a receiving module and a transmission module, the transmission module sending a transmission signal to the antenna matching device, the antenna matching device comprising:
a matching circuit for adjusting a matching impedance according to an adjusting signal, the matching circuit having a first end and a second end, the second end for receiving a receiving signal;
a control unit coupled to the matching circuit, for generating the adjusting signal according to a reflection signal;
a circulator coupled to the first end of the matching circuit, for guiding the transmission signal to the matching circuit, the matching circuit generating the reflection signal corresponding to the transmission signal and thereafter transmitting the reflection signal and the receiving signal to the circulator through the first end; and
a frequency division unit coupled to the circulator, for receiving the reflection signal and the receiving signal from the circulator and outputting the reflection signal and the receiving signal to the control unit and the receiving module according to frequency of the reflection signal and the receiving signal.

2. The antenna matching device according to claim 1, wherein the frequency division unit is a duplexer.

3. The antenna matching device according to claim 1, wherein the frequency division unit comprises a band pass filter and a coupler.

4. The antenna matching device according to claim 1, the antenna matching device further comprising a first coupler coupled to the circulator and the control unit, for sending the transmission signal to the circulator and the control unit, the control unit adjusting the matching circuit according to the reflection signal and the transmission signal.

5. The antenna matching device according to claim 4, wherein the transmission signal has a first power and the reflection signal has a reflection power such that the difference between the first power and the reflection power is used by the control unit to provide an adjusting voltage for adjusting the matching circuit until the difference is close to a predetermined critical value.

6. A method for antenna matching applied in a transceiver, wherein the transceiver including a matching circuit, a circulator, and a control unit, the method comprising the steps of:
obtaining a reflection value generating by the matching circuit according to a transmitting power of the transceiver by the circulator;
providing an adjusting voltage by the control unit to the matching circuit and defining a reference value and a critical value; and
adjusting the adjusting voltage according to the difference between the reference value and the reflection value until the difference substantially equal to the critical value.

7. The method for antenna matching according to claim 6, wherein the reference value is the power transmitted by the transceiver.

8. The method for antenna matching according to claim 6, wherein the critical value is a standard value of optimization.

9. A transceiver comprising:
a receiving module;
a transmission module for sending a transmission signal;
a matching circuit for adjusting a matching impedance according to an adjusting signal, the matching circuit having a first end and a second end, the second end for receiving a receiving signal;
a control unit coupled to the matching circuit, for generating the adjusting signal according to a reflection signal;
a circulator coupled to the first end of the matching circuit, for guiding the transmission signal to the matching circuit, the matching circuit generating the reflection signal corresponding to the transmission signal and thereafter transmitting the reflection signal and the receiving signal to the circulator through the first end; and
a frequency division unit coupled to the circulator, for receiving the reflection signal and the receiving signal from the circulator and outputting the reflection signal and the receiving signal to the control unit and the receiving module according to frequency of the reflection signal and the receiving signal.

10. The transceiver according to claim 9, wherein the frequency division unit is a duplexer.

11. The transceiver according to claim 9, wherein the frequency division unit comprises a band pass filter and a coupler.

12. The transceiver according to claim 9, the antenna matching device further comprising a first coupler coupled to the circulator and the control unit, for sending the transmission signal to the circulator and the control unit, the control unit adjusting the matching circuit according to the reflection signal and the transmission signal.

13. The transceiver according to claim 12, wherein the transmission signal has a first power and the reflection signal has a reflection power such that the difference between the first power and the reflection power is used by the control unit to provide an adjusting voltage for adjusting the matching circuit until the difference is close to a predetermined critical value.
